(19) United States
(12) Patent Application Publication
(10) Pub. No.: US 2014/0214673 A1
(43) Pub. Date: Jul. 31, 2014

(54) METHOD FOR AUTHENTICATION USING BIOMETRIC DATA FOR MOBILE DEVICE E-COMMERCE TRANSACTIONS

(71) Applicants: JIM S. Baca, Corrales, NM (US); Hong Li, El Dorado Hills, CA (US); Tobias M. Kohlenberg, Portland, OR (US); David Stanasolovich, Albuquerque, NM (US); Mark H. Price, Placitas, NM (US)

(72) Inventors: JIM S. Baca, Corrales, NM (US); Hong Li, El Dorado Hills, CA (US); Tobias M. Kohlenberg, Portland, OR (US); David Stanasolovich, Albuquerque, NM (US); Mark H. Price, Placitas, NM (US)

(21) Appl. No.: 13/996,298

(22) PCT Filed: Dec. 21, 2011
(86) PCT No.: PCT/US11/66478

§ 371 Date: Jun. 20, 2013

(51) Int. Cl. G06Q 20/40

(52) U.S. Cl. CPC G06Q 20/40145; G06Q 20/4016
USPC 705/44

(57) ABSTRACT

Generally, this disclosure describes authentication using biometric data for mobile device e-commerce transactions. A method may include capturing a mobile device user's biometric data; comparing the captured biometric data to authorized user biometric data stored on the mobile device; and authenticating an e-commerce transaction if the captured biometric data corresponds to the authorized user biometric data stored on the mobile device.

### FIELD

This disclosure relates to mobile device e-commerce transactions, more particularly to authentication using biometric data to confirm user identity.

### BACKGROUND

Near field communication (NFC) allows for simplified transactions, data exchange and wireless connections between two devices in close proximity (typically a few centimeters) to each other. Many mobile devices (e.g., smartphones) contain embedded NFC chips that can send encrypted data a short distance (i.e., “near field”) to a reader located, for example, next to a retail cash register. Shoppers who have their credit card information stored in their NFC-capable smartphones may then pay for their purchases by waving their smartphones near the reader or tapping their smartphones on the reader rather than producing the actual credit (or debit) card. Thus, since NFC may be used for monetary transactions, it is important to ensure that the smartphone can confirm the identity of the shopper, i.e., can confirm that the shopper is an authorized user of the device.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts, and in which:

FIG. 1 illustrates an authentication system using biometric data consistent with various embodiments of the present disclosure;

FIG. 2 illustrates a flowchart of exemplary operations consistent with various embodiments of the present disclosure;

FIG. 3 illustrates a flowchart of exemplary operations consistent with an embodiment of the present disclosure; and

FIG. 4 illustrates a flowchart of exemplary operations for secondary authentication consistent with an embodiment of the present disclosure.

Although the following Detailed Description will proceed with reference being made to illustrative embodiments, many alternatives, modifications, and variations thereof will be apparent to those skilled in the art.

### DETAILED DESCRIPTION

Generally, this disclosure describes techniques for authenticating mobile device e-commerce transactions using biometric data. The authentication is configured to confirm that a device user that is attempting to conduct the transaction is an authorized user. As used herein, mobile e-commerce transactions may include, but are not limited to, on-line banking, on-line purchasing (of goods and/or services), on-line auction, point of sale (PoS) transactions and/or other electronic transactions that may be performed using a mobile device. The mobile device may include an e-wallet configured to store the authorized user's credit and/or debit card information and/or bank account information. The biometric data is configured to perform a similar function as a PIN (personal identification number) associated with credit/debit card transactions, i.e., confirm that a card user is an authorized user. However, credit/debit card numbers and PINs may be acquired by an unauthorized user thereby allowing the unauthorized user to perform unauthorized transactions.

Biometric data includes physical characteristics of a person that may be used to identify the person. For example, physical characteristics include, but are not limited to, facial characteristics, hand characteristics (e.g., fingerprint characteristics, characteristics of hand geometry and patterns of veins), eye characteristics (e.g., retina characteristics (e.g., retina capillary structure) and iris characteristics), odor/scent, voice and/or other physical characteristics that may be used to identify the person. Biometric data may also include behavioral characteristics such as gait. While a PIN may be anonymous, biometric data is typically tightly tied to a specific person and may not be usable without the presence of the specific person. Thus, authentication using biometric data may provide a stronger authentication than is possible using a PIN.

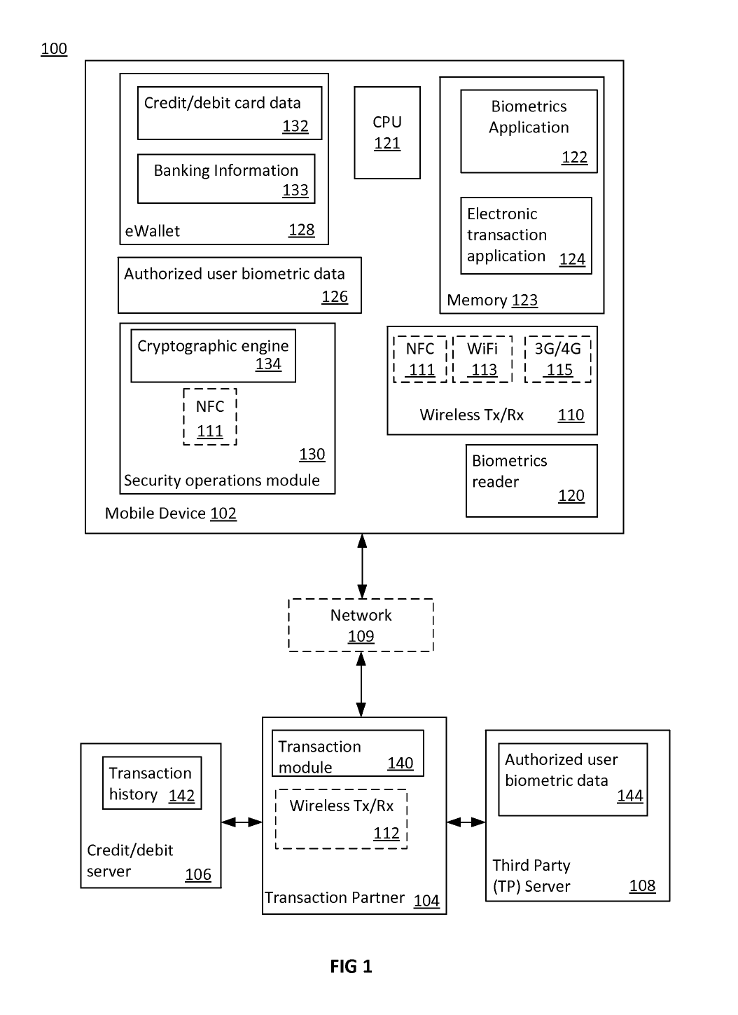

FIG. 1 illustrates an authentication system 100 using biometric data consistent with various embodiments of the present disclosure. The system 100 generally includes a mobile device 102 and a transaction partner 104. The system 100 may further include a credit/debit server 106 and/or a third-party server (TP) server 108. Depending on the particular transaction partner 104, the system 100 may include a network configured to connect the mobile device 102 and the transaction partner 104, as described herein.

Mobile devices include, but are not limited to, mobile telephones, smartphones, tablet computers, notebook computers, ultraportable computers, ultramobile computers, netbook computers, subnotebook computers, personal digital assistants, enterprise digital assistants, mobile internet devices and personal navigation devices. Small form factor (SFF) devices, a subset of mobile devices, typically include hand-held mobile devices (i.e., hand-held devices with at least some computing capability).

Transaction partners include, but are not limited to, Point of Sale (PoS) devices (e.g., cash registers), public kiosks with internet connectivity, public web portals, and/or other electronic commerce transaction partners. The credit/debit server 106 may include a banking server and/or a server configured to provide credit card transaction support. The TP server 108 is configured to provide secondary authentication, as described herein. Credit/debit server 106 may be included in a plurality of servers configured to provide credit/debit card. TP server 108 may be included in a plurality of servers configured to provide third party authentication service. In other words, although shown as individual servers for ease of illustration, servers 106 and 108 may be included in a plurality of servers in, e.g., a cloud service.

Mobile device 102 is configured to communicate with transaction partner 104 using one or more wireless communication protocols including, but not limited to, NFC, RFID and Bluetooth for near field communication, and Wi-Fi, 3 G and 4 G for network connections, and/or some other wireless signal and/or communication protocol. Mobile device 102 may include a wireless transmitter/receiver Tx/Rx 110 configured to transmit and receive using one or more of the communication protocols, as described herein. Mobile device 102 may include an NFC module, NFC 111, configured for near field communication, and Wi-Fi module, Wi-Fi 113 and/or 3 G/4 G module, 3 G/4 G 115, configured for network communication. The type of communication may depend on the particular transaction partner and/or the type of connection to the transaction partner. For example, for e-commerce transactions between mobile device 102 and a PoS device (e.g., cash register), the communication protocol used may include relatively near field communication protocols such as NFC, RFID and/or Bluetooth. In this example, the transaction partner 104 may include a wireless Tx/Rx 112 configured for relatively near field communication. In another example, e.g., when the transaction partner is a web portal, the communication protocol used may correspond to Wi-Fi, 3 G or 4 G. In this example, mobile device 102 may communicate with transaction partner 104 via a network, e.g., network 109.

Mobile device 102 may include a biometrics reader 120, a biometrics application 122, an electronic transaction application 124, authorized user biometric data 126, an e-wallet 128 and a security operations module 130. Mobile device 102 may include circuitry CPU 121 configured to perform operations associated with applications 122 and 124, and memory 123 configured to store the applications 122, 124. E-wallet corresponds to “electronic wallet” and may include payment cards that are stored electronically on the mobile device 104. The e-wallet 128 may include credit and/or debit card data 132 and/or may include banking information 133. Credit/debit card data may include card number(s), card holder name, security code and/or expiration date(s). Banking information may include bank routing number(s) and/or bank account number(s). In some embodiments, the security operations module 130 may include a cryptographic engine 134, as described herein.

The biometrics reader 120 is configured to capture a device user's biometric data. For example, the biometrics reader may be a fingerprint reader. In this example, the device user may be requested to place a finger on the mobile device 102. An image of the device user's fingerprint may then be captured by biometrics reader 120.

Biometrics application 122 is configured to manage the biometrics reader 120, to compare the device user's captured biometric data to the authorized user's biometric data 126 and to communicate the result of the comparison to the electronic transaction application 124. For example, the device user may launch the electronic transaction application 124 when the device user wishes to make a purchase. The device user may launch the electronic transaction application 124 by, e.g., selecting an icon displayed on the mobile device 102.

The electronic transaction application 124 may then launch the biometrics application 122 to capture the device user's biometric data and compare the captured device user's biometric data with the authorized user's biometric data 126 previously stored in the mobile device 102. If the device user's biometric data does not correspond to the authorized user's biometric data, the device user may be requested to provide his/her biometric data again. If the device user's biometric data does not correspond to the authorized user's biometric data after a number (e.g., three) of retries, then the authentication may fail. If the authentication fails, the device user's biometric data may be provided to, e.g., TP server 108, to be stored for later use. For example, if mobile device 102 has been lost or stolen, the stored device user's biometric data may be used to identify this device user.

The biometrics application 122 may then report the results of the comparison to the electronic transaction application 124. If the device user's biometric data corresponds to the authorized user's biometric data 126, the electronic transaction application 124 may proceed with the transaction. If the device user's biometric data does not correspond to the authorized user's biometric data 126, the electronic transaction application 124 may halt the transaction. It should be noted that although the biometrics application 122 and the electronic transaction application 124 are shown separately in FIG. 1, they may be included (i.e., combined) in one application, e.g., the electronic transaction application 124.

Thus, an e-commerce transaction using a mobile device may be authenticated using biometric data. A device user may be requested to provide biometric data in response to initiating the e-commerce transaction. The device user's biometric data may then be compared to an authorized user biometric data stored on the mobile device. If the device user's biometric data corresponds to the authorized user biometric data, the e-commerce transaction may proceed. If not, the e-commerce transaction may be halted.

In some embodiments, mobile device 102 may include security operations module 130. Security operations module 130 may be included in secure circuitry that is generally inaccessible to applications (other than electronic transaction application 124 and/or biometrics application 120) configured to perform operations on mobile device 102 and/or devices (e.g., transaction partner 104) that may be communicating with mobile device 102. Security operations module 130 may be configured to store and/or limit access to authorized user biometric data 126. Security operations module 130 may be further configured to limit access to e-wallet 128 and/or credit/debit card data 132.

In an embodiment, security operations module 130 may include the NFC module 111. In this embodiment, additional security may be provided by limiting access to the NFC module 111 using the security operations module 130. In another embodiment, access to the security operations module 130 may be through the NFC module 111. Thus, in some embodiments, NFC module 111 may be included in the security operations module 130 and in other embodiments, NFC module 111 may not be included in security operations module 130 (e.g., may be included in wireless Tx/Rx 110).

Security operations module 130 may include cryptographic engine 134. Cryptographic engine 134 is configured to generate a signature based on biometric data using cryptographic techniques. For example, an authorized user's biometric data may be provided to the cryptographic engine 134 that may then generate an authorized user electronic signature based on the authorized user biometric data using, e.g., a private key. The authorized user electronic signature may then be stored in the mobile device 102, e.g., in security operations module 130. Thereafter, when a device user initiates an e-commerce transaction, the device user's biometric data may be processed by, e.g., the cryptographic engine 134, to generate a device user electronic signature. If the electronic signatures correspond to each other, the transaction may be authenticated and thus may proceed. Thus, generating an electronic signature based on an authorized user biometric data may provide an additional level of security. An unauthorized user may be unable to generate the authorized electronic signature without both the authorized user biometric data and the private encryption key.

Transaction partner 104 may include a transaction module 140. Transaction module 140 is configured to manage e-commerce transactions between mobile device 102 and transaction partner 104. Transaction partner 104 may be coupled to credit/debit server 106 and/or TP server 108, e.g., via a network. When mobile device 102 initiates an e-commerce transaction, transaction module 140 is configured to complete the transaction. For example, if transaction partner 104 is a PoS device, transaction module 140 may be configured to transmit a charge amount associated with the transaction to credit/debit server 106 and to await a confirmation to complete the transaction. In another example, if transaction partner is a banking web portal and the e-commerce transaction is a banking transaction, transaction module 140 complete the transaction without communicating with another server, e.g., credit/debit server 106.

Credit/debit server 106 may include a transaction history 142 for each associated debit/credit card account managed by credit/debit server 106. Transaction history 142 may be used to confirm (or deny) a pending e-commerce transaction. The transaction history 142, for example, may be used in a secondary authentication. The transaction history 142 may be updated in response to completed or halted e-commerce transactions. For example, the transaction history 142 may be updated to reflect a failed authentication. In this example, the transaction history may be updated to include an indicator that the mobile device may be possessed by an unauthorized user, e.g., may be stolen.

In some embodiments, an e-commerce transaction that has been authenticated using device user biometric data captured by the mobile device 102 may be subjected to a secondary authentication. The secondary authentication may be performed by transaction partner 104 and/or TP server 108. Device user biometric data may be provided to transaction partner 104 and/or TP server 108 by mobile device 102. TP server may include authorized user biometric data 144. TP server 108 may further include a third party registry, e.g., a certificate authority service, a trusted notary service and/or a law enforcement entity. The TP server authorized user biometric data 144 may be provided to the transaction partner 104. The TP server authorized user biometric data 144 may then be used to verify the captured device user biometric data and authenticate the e-commerce transaction. If the authentication fails, the e-commerce transaction may be halted.

For example, the transaction partner 104 may request additional verification (i.e., secondary authentication) that the device user is an authorized device user from a trusted third party (e.g., TP server 108) based on transaction history 142. For example, the transaction history 142 may include an indicator that the mobile device 102 may have been stolen. The captured device user biometric data may be provided to a law enforcement entity, if the captured device user biometric data does not correspond to the authorized user biometric data 144 stored on the trusted TP server 108. The captured device user biometric data may then be used to identify the device user. The transaction history 142 may be further updated to confirm that the mobile device 102 is not possessed by the authorized user.

Thus, mobile device 102 may be configured to authenticate a device user based on device user biometric data. Authentication may be initiated in response to the device user initiating an e-commerce transaction, e.g., by accessing transaction partner 104 via wireless communication. The wireless communication may be relatively near field (e.g., NFC, RFID, Bluetooth) and/or may include Wi-Fi, 3 G or 4 G, depending on the transaction partner being accessed. A second level of authentication may be performed using TP server authorized user biometric data 144.

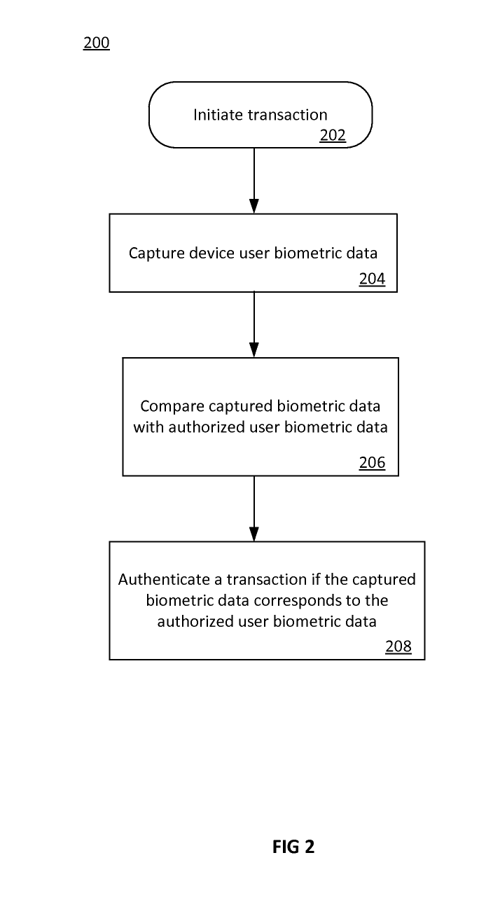

FIG. 2 illustrates a flowchart 200 of exemplary operations consistent with various embodiments of the present disclosure. The operations may be performed, for example, by mobile device 102, transaction partner 104 and/or TP server 108. In particular, flowchart 200 depicts exemplary operations configured to provide e-commerce transaction authentication based on user biometric data. The operations of flowchart 200 may begin with initiation 202 of an e-commerce transaction. For example, a device user may launch an electronic transaction application on the mobile device while in proximity to a PoS device or when connected to a web portal. Operation 204 includes capturing device user biometric data. The device user biometric data may be provided and captured in response to a request to the device user to provide the biometric data. For example, the device user may be requested to place his/her finger on a fingerprint reader (e.g., biometrics reader 120). In another example, the device user may be requested to align his/her eye with an iris reader. The device user's biometric data may then be captured.

The captured biometric data may be compared with authorized user biometric data at operation 206. If the captured biometric data corresponds to the authorized user biometric data, the e-commerce transaction may be authenticated at operation 208.

Thus, an e-commerce transaction using an mobile device may be authenticated based on user biometric data. Unlike a PIN, an unauthorized user may not easily possess the authorized user biometric data. Authentication based on biometric data may therefore provide a higher level of security than a PIN may provide. Further, authentication based on biometric data does not require the user to remember a PIN, providing a relatively reliable, relatively simple to use, authentication method.

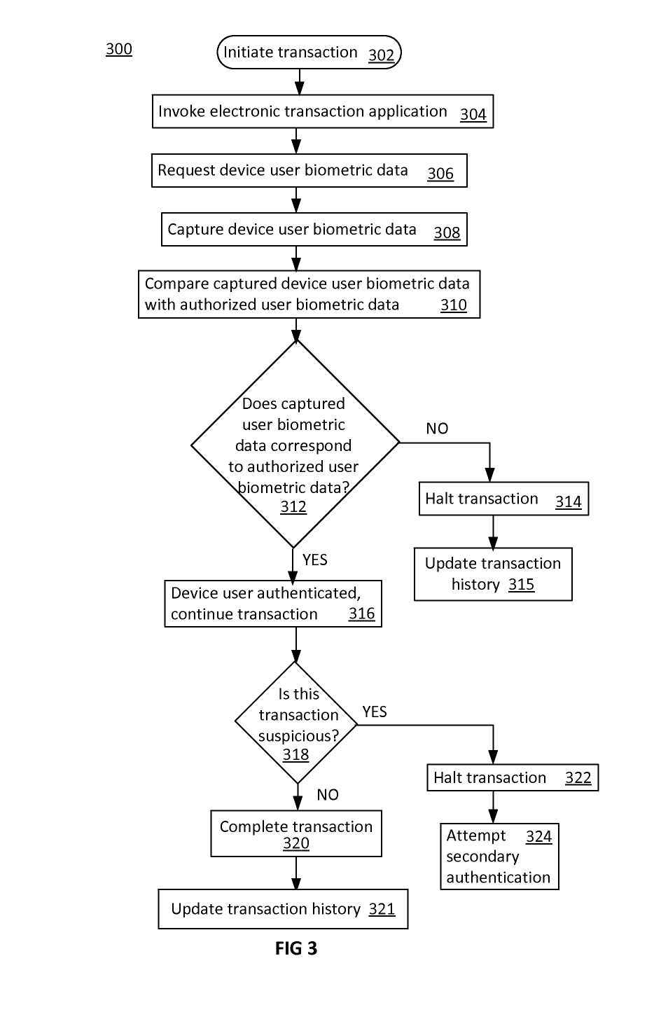

FIG. 3 illustrates a flowchart 300 of exemplary operations consistent with an embodiment of the present disclosure. The operations may be performed, for example, by mobile device 102, transaction partner 104, credit/debit server 106 and/or TP server 108. In particular, flowchart 300 depicts exemplary operations configured to provide e-commerce transaction authentication based on user biometric data.

The operations of flowchart 300 may begin 302 with initiation of an e-commerce transaction, i.e., the device user wishes to make a purchase or perform an on-line banking or on-line payment operation. An electronic transaction application may be invoked at operation 304. The electronic transaction application may be configured to conduct the e-commerce transaction. Operation 306 may include requesting device user biometric data. Device user biometric data may be captured at operation 308. Device user biometric data may be compared with authorized user biometric data at operation 310. Whether the captured device user biometric data corresponds to the authorized user biometric data may be determined at operation 312. If the captured device user biometric data does not correspond to the authorized user biometric data, the transaction may be halted at operation 314. Operation 315 may include updating a transaction history to reflect the failed authentication and halted transaction. For example, the transaction history 142 stored in the credit/debit server 106 may be updated. If the captured device user biometric data corresponds to the authorized user biometric data, the device user may be authenticated and the transaction may be continued at operation 316.

Operation 318 includes determining whether the transaction may be suspicious. For example, a transaction may be deemed suspicious based on a transaction history. If the transaction is not deemed suspicious, the e-commerce transaction may be completed at operation 320. Operation 321 may include updating a transaction history to reflect the authenticated and completed transaction. For example, the transaction history stored in the credit/debit server 106 may be updated. If the transaction is deemed suspicious, the e-commerce transaction may be halted at operation 322. An attempt to provide a secondary authentication may be performed at operation 324. For example, authorized user biometric data stored in a TP server may be accessed to attempt to provide a secondary authentication.

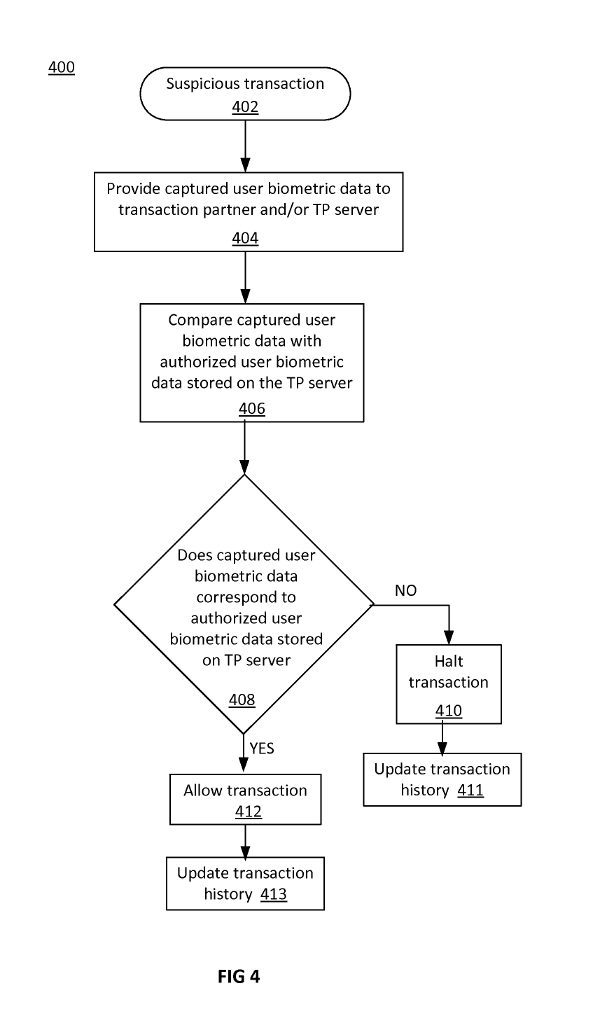

FIG. 4 illustrates a flowchart 400 of exemplary operations for secondary authentication consistent with an embodiment of the present disclosure. The operations of flowchart 400 may be performed, for example, by mobile device 102, transaction partner 104, credit/debit server 106 and/or TP server 108. In particular, flowchart 400 depicts exemplary operations configured to provide secondary authentication of an e-commerce transaction based on user biometric data when a transaction has been deemed suspicious.

The operations of flowchart 400 may begin 402 with an indication that an e-commerce transaction may be suspicious. For example, an e-commerce transaction may be deemed suspicious by a credit/debit server based on a user's transaction history and/or an attempted current transaction. Operation 404 includes providing captured device user biometric data to a transaction partner and/or a TP server. The TP server may be configured to store previously provided authorized user biometric data. The TP server may include a third party registry, e.g., a certificate authority, a trusted notary service and/or a law enforcement entity.

The captured device user biometric data may be compared to authorized user biometric data stored on a TP server at operation 406. For example, the captured device user biometric data and the authorized user biometric data may be provided to the transaction partner and the transaction partner may conduct the comparison. In another example, the captured device user biometric data may be provided to the TP server that may then conduct the comparison. Whether the captured device user biometric data corresponds to the stored authorized user biometric data may be determined at operation 408. If the captured device user biometric data does not correspond to the stored authorized user biometric data, the transaction may be halted at operation 410. Appropriate authority (e.g., law enforcement, bank, issuer of credit/debit card) may then be notified. Operation 411 may include updating a transaction history to reflect the failed authentication and halted transaction. If the captured device user biometric data corresponds to the stored authorized user biometric data, the e-commerce transaction may be allowed at operation 412. Operation 413 may include updating a transaction history to reflect the authenticated and completed transaction.

In this manner, an e-commerce transaction that is initiated by a device user and has been authenticated based on authorized user biometric data stored on the mobile device may be subjected to a secondary authentication process. The secondary authentication may be triggered by, e.g., user transaction history. User transaction history may include an indicator whether the mobile device is suspected stolen. For example, the indicator may be stored in the transaction history in response to a halted transaction (e.g., because of a failed authentication).

Thus, mobile device e-commerce transactions may be authenticated based on user biometric data. Device user biometric data may be captured in response to initiating an e-commerce transaction between an mobile device and a transaction partner. The mobile device may be configured to capture the device user's biometric data and to compare the captured biometric data to previously stored authorized user biometric data. If the captured biometric data corresponds to the authorized user biometric data, the e-commerce transaction may be authenticated. User privacy may be maintained by performing the authentication in the mobile device so that authenticated user biometric data is not provided to the transaction partner. If the authentication fails, then the captured device user biometric data may be provided to the transaction partner and/or a TP server, e.g., associated with law enforcement. If an authenticated transaction that has been authenticated by the mobile device, based on authorized user biometric data stored on the mobile device, is later deemed suspicious (e.g., by a credit/debit server), secondary authentication may be attempted by the transaction partner or a TP server based on authorized user biometric data stored in the TP server. Thus, a relatively strong e-commerce authentication may be performed based on user biometric data.

While FIGS. 4 and 5 illustrate various operations according an embodiment, it is to be understood that not all of the operations depicted in FIGS. 4 and 5 are necessary for other embodiments. Indeed, it is fully contemplated herein that in other embodiments of the present disclosure, the operations depicted in FIGS. 4 and 5 and/or other operations described herein may be combined in a manner not specifically shown in any of the drawings, but still fully consistent with the present disclosure. Thus, claims directed to features and/or operations that are not exactly shown in one drawing are deemed within the scope and content of the present disclosure.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical locations. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

While the foregoing is prided as exemplary system architectures and methodologies, modifications to the present disclosure are possible. For example, memory, e.g., mobile device memory 123, transaction partner memory and/or server memory may comprise one or more of the following types of memory: semiconductor firmware memory, programmable memory, non-volatile memory, read only memory, electrically programmable memory, random access memory, flash memory, magnetic disk memory, and/or optical disk memory. Additionally or alternatively, mobile device memory, transaction partner memory and/or server memory may comprise other and/or later-developed types of computer-readable memory.

Mobile device 102 may be configured to communicate with transaction partner 104 and/or network 109 using a variety of communication protocols. The communications protocols may include but are not limited to wireless communications protocols, such as NFC, RFID, Bluetooth, Wi-Fi, 3 G, 4 G and/or other communication protocols.

The NFC and/or RFID communication signal and/or protocol may comply or be compatible with one or more NFC and/or RFID standards published by the International Standards Organization (ISO) and/or the International Electrotechnical Commission (IEC), including ISO/IEC 14443, titled: Identification cards—Contactless integrated circuit cards—Proximity cards, published in 2008; ISO/IEC 15693: Identification cards—Contactless integrated circuit cards—Vicinity cards, published in 2006, titled: ISO/IEC 18000, titled: Information technology—Radio frequency identification for item management, published in 2008; and/or ISO/IEC 18092, titled: Information technology—Telecommunications and information exchange between systems—Near Field Communication—Interface and Protocol, published in 2004; and/or later versions of these standards.

The Bluetooth protocol may comply or be compatible with the 802.15.1 standard published by the IEEE, titled “IEEE 802.15.1-2005 standard, IEEE Standard for Information technology—Telecommunications and information exchange between systems—Local and metropolitan area networks—Specific requirements Part 15.1: Wireless Medium Access Control (MAC) and Physical Layer (PHY) Specifications for Wireless Personal Area Networks (W Pans)”, published in 2005, and/or later versions of this standard.

The Wi-Fi protocol may comply or be compatible with the 802.11 standards published by the Institute of Electrical and Electronics Engineers (IEEE), titled “IEEE 802.11-2007 Standard, IEEE Standard for Information Technology—Telecommunications and Information Exchange Between Systems—Local and Metropolitan Area Networks—Specific Requirements—Part 11: Wireless LAN Medium Access Control (MAC) and Physical Layer (PHY) Specifications” published, Mar. 8, 2007, and/or later versions of this standard.

The 3 G protocol may comply or be compatible with the International Mobile Telecommunications (IMT) standard published by the International Telecommunication Union (ITU), titled “IMT-2000”, published in 2000, and/or later versions of this standard. The 4 G protocol may comply or be compatible with IMT standard published by the ITU, titled “IMT-Advanced”, published in 2008, and/or later versions of this standard.

For example, network 109 may comprise a packet switched network. Mobile device 102 may be capable of communicating with the transaction partner 104 using a selected packet switched network communications protocol. One exemplary communications protocol may include an Ethernet communications protocol which may be capable permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in March, 2002 and/or later versions of this standard. Alternatively or additionally, mobile device 102 may be capable of communicating with the transaction partner 104, using an X.25 communications protocol. The X.25 communications protocol may comply or be compatible with a standard promulgated by the International Telecommunication Union-Telecommunication Standardization Sector (ITU-T). Alternatively or additionally, mobile device 102 may be capable of communicating with the transaction partner 104, using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, mobile device 102 may be capable of communicating with the transaction partner 104, using an Asynchronous Transfer Mode (ATM) communications protocol. The ATM communications protocol may comply or be compatible with an ATM standard published by the ATM Forum titled “ATM-MPLS Network Interworking 1.0” published August 2001, and/or later versions of this standard. Of course, different and/or after-developed connection-oriented network communication protocols are equally contemplated herein.

“Circuitry”, as used in any embodiment herein, may comprise, for example, singly or in any combination, hardwired circuitry, programmable circuitry, state machine circuitry, and/or firmware that stores instructions executed by programmable circuitry. An application (“app”) and/or module, as used in any embodiment herein, may be embodied as circuitry. The circuitry may be embodied as an integrated circuit, such as an integrated circuit chip.

Thus, the present disclosure provides a method and system for mobile device e-commerce transaction authentication using biometric data. The mobile device is configured to verify the identity of a device user by capturing the device user's biometric data and comparing the captured device user's biometric data to authorized user biometric data stored, e.g., in the mobile device. A secondary authentication may be performed if the transaction is deemed suspicious. A relatively strong authentication is thus provided using the biometric data.

According to one aspect there is provided a method. The method may include capturing a mobile device user's biometric data; comparing the captured biometric data to authorized user biometric data stored on the mobile device; and authenticating an e-commerce transaction if the captured biometric data corresponds to the authorized user biometric data stored on the mobile device.

According to another aspect there is provided a system. The system may include a mobile device. The mobile device may include a biometrics reader configured to capture the mobile device user's biometric data; and a memory configured to store authorized user biometric data, wherein the mobile device is configured to compare the captured biometric data to the authorized user biometric data stored on the mobile device and authenticate an e-commerce transaction if the captured biometric data corresponds to the authorized user biometric data stored on the mobile device.

According to another aspect there is provided a system. The system may include one or more storage mediums having stored thereon, individually or in combination, instructions that when executed by one or more processors result in the following operations comprising: capturing a mobile device user's biometric data; comparing the captured biometric data to authorized user biometric data stored on the mobile device; and authenticating an e-commerce transaction if the captured biometric data corresponds to the authorized user biometric data stored on the mobile device.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-15. (canceled)

16. A method comprising:
capturing a mobile device user's biometric data;
comparing the captured biometric data to authorized user biometric data stored on the mobile device; and
authenticating an e-commerce transaction if the captured biometric data corresponds to the authorized user biometric data stored on the mobile device.

17. The method of claim 16, further comprising:
communicating with a transaction partner using a near field communication protocol.

18. The method of claim 16, further comprising:
determining whether the e-commerce transaction is suspicious based on a transaction history.

19. The method of claim 16, further comprising:
performing a secondary authentication based on the captured biometric data and authorized user biometric data stored on a third party server.

20. The method of claim 19, wherein the secondary authentication is performed by a transaction partner.

21. The method of claim 16, wherein the authorized user biometric data stored in the mobile device is encrypted.

22. The method of claim 16, wherein the biometric data comprises a fingerprint, a hand geometry, a hand vein configuration, an iris characteristic or a retina capillary structure characteristic.

23. A system comprising:
a mobile device, comprising:
a biometrics reader configured to capture the mobile device user's biometric data; and
a memory configured to store authorized user biometric data,
wherein the mobile device is configured to compare the captured biometric data to the authorized user biometric data stored on the mobile device and authenticate an e-commerce transaction if the captured biometric data corresponds to the authorized user biometric data stored on the mobile device.

24. The system of claim 23, wherein the mobile device further comprises an e-wallet configured to store at least one of credit card data, debit card data, and banking information of an authorized user.

25. The system of claim 23, wherein the mobile device further comprises a cryptographic engine configured to encrypt the authorized user biometric data stored on the mobile device.

26. The system of claim 23, further comprising a transaction partner configured to perform a secondary authentication based on the captured biometric data and authorized user biometric data stored on a third party server.

27. The system of claim 23, wherein the biometrics reader is configured to capture a fingerprint, a hand geometry, a hand vein configuration, an iris characteristic or a retina capillary structure characteristic.

28. The system of claim 23, wherein the mobile device is configured to communicate with a transaction partner using a near field communication protocol.

29. A system comprising one or more storage mediums having stored thereon, individually or in combination, instructions that when executed by one or more processors result in the following operations comprising:
capturing a mobile device user's biometric data;
comparing the captured biometric data to authorized user biometric data stored on the mobile device; and
authenticating an e-commerce transaction if the captured biometric data corresponds to the authorized user biometric data stored on the mobile device.

30. The system of claim 29, wherein the instructions that when executed by one or more processors results in the following additional operations:
communicating with a transaction partner using a near field communication protocol.

31. The system of claim 29, wherein the instructions that when executed by one or more processors results in the following additional operations:
determining whether the e-commerce transaction is suspicious based on a transaction history.

32. The system of claim 29, wherein the instructions that when executed by one or more processors results in the following additional operations:
performing a secondary authentication based on the captured biometric data and authorized user biometric data stored on a third party server.

33. The system of claim 29, wherein the secondary authentication is performed by a transaction partner.

34. The system of claim 29, wherein the authorized user biometric data stored in the mobile device is encrypted.

35. The system of claim 29, wherein the biometric data comprises a fingerprint, a hand geometry, a hand vein configuration, an iris characteristic or a retina capillary structure characteristic.
